(19) United States
(12) Patent Application Publication
(10) Pub. No.: US 2017/0279222 A1
(43) Pub. Date: Sep. 28, 2017

(54) LEVER-TYPE CONNECTOR

(71) Applicant: Sumitomo Wiring Systems, Ltd., Yokkaichi, Mie (JP)

(72) Inventor: Keita Kayano, Yokkaichi, Mie (JP)

(21) Appl. No.: 15/518,569

(22) PCT Filed: Oct. 14, 2015
(86) PCT No.: PCT/JP2015/078982

§ 371 Date: Apr. 12, 2017

(30) Foreign Application Priority Data
Nov. 4, 2014 (JP) 2014-224400

(51) Int. Cl. H01R 13/629; H01R 13/641

(52) U.S. Cl. CPC H01R 13/62933; H01R 13/62977; H01R 13/62938; H01R 13/641; H01R 13/62922; H01R 13/639

(57) ABSTRACT

A lever-type connector (1) has a connector housing (10), and a lever (20) including cam plates (21) having cam grooves (23) for receiving cam followers (34) of a mating housing (30). The lever (20) includes push-back pieces (27) retracted from an opening edge (13E) of the connector housing (10) facing the mating housing (30) and extending from the cam plates (21). The connector housing (10) includes push-back piece receiving portions (18) configured to bias the lever (20) from a proper connection position to an initial position by butting against the push-back pieces (27) when the lever (20) is at the proper connection position. An angle (a) of a corner part (C) formed by a line connecting a center of rotation of the lever (20) and a base (27R) of the push-back piece (27) connected to the cam plate (21) and the push-back piece (27) is larger than 90°.

### TECHNICAL FIELD

A technique disclosed by this specification relates to a lever-type connector.

### BACKGROUND ART

A lever-type connector is a connector with a connector housing for holding terminal fittings and a lever including a cam plate and to be mounted on the connector housing. The cam plate includes a cam groove to be engaged with a cam follower of a mating housing. In connecting the connector housing and the mating housing, both connectors can be easily connected with a small force by a cam action between the cam groove and the cam follower according to the rotation of the lever from an initial position to a proper connection position after the housings are opposed to each other and initially connected.

A connector with a flexible piece for detecting that a lever has not reached a connection position and a housing has not been properly connected to a mating housing (incompletely connected state) and a protrusion for deflecting this flexible piece is known as a connector as described above (see patent literature 1).

In such a connector, the flexible piece comes into contact with the protrusion to be deflected according to the rotation of the lever. If a rotational operation of the lever is stopped although the both connectors are in an incompletely connected state, the lever is pushed back in a return direction to the initial position by a restoring force of the flexible piece. In this way, incomplete connection can be detected.

### CITATION LIST

### Patent Literature

Patent Literature 1: Japanese Unexamined Patent Publication No. H10-112351

### SUMMARY OF INVENTION

### Technical Problem

There has been an increasing demand to miniaturize connectors in recent years. It is thought as one method for miniaturizing a connector to arrange a lever at a position of a connector housing retracted from a surface of the connector housing facing a mating housing. However, if this configuration is employed, a flexible piece becomes shorter and incomplete connection detection capability may be reduced.

### Solution to Problem

A lever-type connector disclosed by this specification is a connector to be connected to a mating housing including a cam follower, and is provided with a connector housing and a lever including a cam plate portion having a cam groove for receiving the cam follower and configured to relatively pull the mating housing toward the connector housing by a cam action of the cam groove and the cam follower as the cam plate portion is rotated from an initial position for allowing the entrance of the cam follower into the cam plate portion to a proper connection position, wherein the lever includes a push-back portion extending from the cam plate portion and retracted from an end edge of the connector housing facing the mating housing, the connector housing includes a push-back piece receiving portion configured to bias the lever from the proper connection position toward the initial position by coming into contact with the push-back portion when the lever is at the proper connection position, and an angle of a corner part formed by a line connecting a center of rotation of the lever and one end part of the push-back portion connected to the cam plate portion and the push-back portion is larger than 90°.

According to the above configuration, for the purpose of miniaturizing the lever-type connector, the cam plate portion is retracted from the end edge of the connector housing facing the mating housing. That is, the cam plate portion is miniaturized by as much as it is more retracted than before. Thus, the push-back portion becomes shorter and a resilient restoring force becomes weaker by as much as the cam plate portion is miniaturized, whereby incomplete connection detection capability may be reduced.

To solve this problem, the angle of the corner part formed by the line connecting the center of rotation of the lever and the one end part of the push-back portion connected to the cam plate portion and the push-back portion is made larger than 90°. By setting such a large angle of the corner part formed by the line connecting the center of rotation of the lever and the one end part of the push-back portion and the push-back portion, the push-back portion can be arranged with a large inclination with respect to a direction in which the cam plate portion is miniaturized, i.e. arranged in a direction in which a larger space is present, and sufficient length and deflection margin of the push-back portion can be ensured. In this way, it is possible to avoid a reduction of the incomplete connection detection capability while realizing the miniaturization of the lever-type connector.

Following configurations are preferable as modes of the technique disclosed by this specification.

The push-back portion may include a body portion connected to the cam plate portion and a hook portion connected to an extending end of the body portion and extending at an angle to the body portion, and the body portion may be tapered from the one end part toward the extending end.

According to this configuration, the deformation of the one end part connected to the cam plate portion can be relatively reduced and a reduction of the incomplete connection detection capability by the plastic deformation of the push-back portion can be avoided by making the bending of a part of the body portion near a tip larger.

Further, the hook portion may have the same thickness over the entire length. According to this configuration, it is possible to avoid that a tip part of the push-back portion is excessively bent and suppress that the push-back portion is disengaged from the push-back piece receiving portion.

### EFFECT

According to the technique disclosed by this specification, it is possible to avoid a reduction of incomplete connection detection capability while realizing the miniaturization of a lever-type connector.

### BRIEF DESCRIPTION OF DRAWINGS

FIG. 1 is a partial section showing a state before a lever-type connector is connected to a mating connector,

FIG. 2 is a partial section showing a state in an initial stage of connection of the lever-type connector to the mating connector,

FIG. 3 is a partial section showing a state where a lever starts rotating while the lever-type connector is being connected to the mating connector,

FIG. 4 is a partial section showing a state where a push-back portion comes into contact with a push-back piece receiving portion while the lever-type connector is being connected to the mating connector,

FIG. 5 is a partial section showing a state where the push-back portion is deflected by the push-back piece receiving portion while the lever-type connector is being connected to the mating connector, and

FIG. 6 is a partial section showing a state where the connection of the lever-type connector to the mating connector is completed.

### EMBODIMENTS OF INVENTION

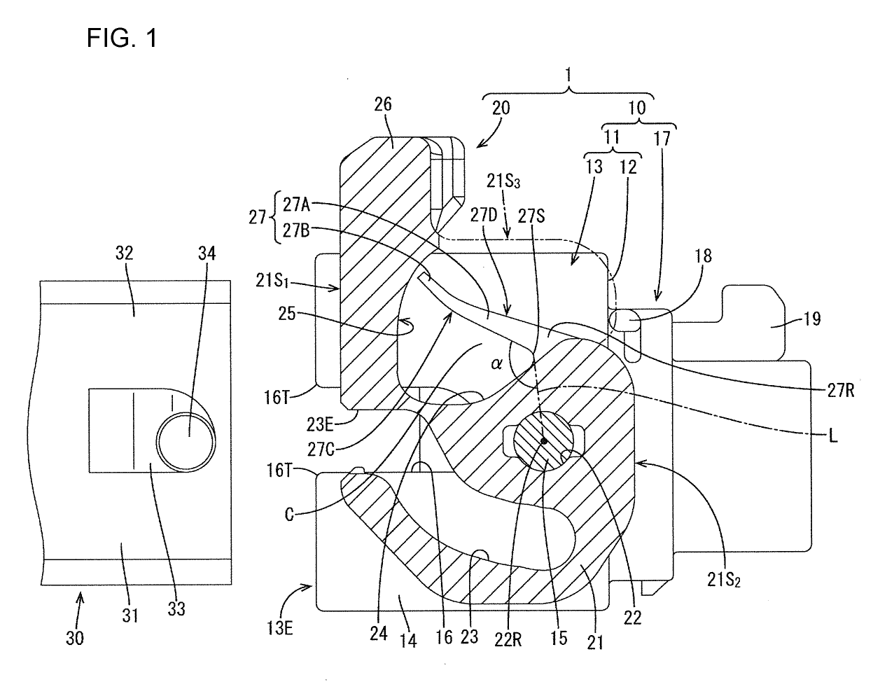

An embodiment is described with reference to FIGS. 1 to 6. A lever-type connector 1 of this embodiment includes a connector housing 10 (hereinafter, abbreviated as a “housing 10”) to be connected to a mating housing 30 and a lever 20 to be assembled with this connector housing 10.

[Configuration of Mating Housing 30]

First, the configuration of the mating housing 30 is described. As shown in FIG. 1, the mating housing 30 includes a tubular small receptacle 31. Although not shown in detail, male terminal fittings are arranged in the small receptacle 31. The small receptacle 31 includes a pair of facing wall portions 32 arranged opposite to each other, and one pedestal portion 33 and one cam follower 34 are arranged on each of the pair of facing wall portions 32. Note that only one of the pair of facing wall portions 32 is shown in FIGS. 1 to 6 due to space limitations. The pedestal portion 33 is a projecting portion projecting outward from each facing wall portion 32. The cam follower 34 is a cylindrical part projecting outward from each pedestal portion 33.

[Configuration of Lever-Type Connector 1]

Next, the configuration of the lever-type connector 1 is described.

As described above, the lever-type connector 1 includes the housing 10 and the lever 20. The housing 10 is made of synthetic resin and includes, as shown in FIG. 1, a fitting tube portion 11 and a terminal accommodating portion 17.

The fitting tube portion 11 includes a plate-like back wall portion 12 and a tubular large receptacle 13 extending forward in a connecting direction to the mating housing 30 from the peripheral edge of the back wall portion 12. The large receptacle 13 is open toward a side facing the mating housing 30 and an end edge facing the mating housing 30 serves as an opening edge 13E. The terminal accommodating portion 17 is formed into a block shape and arranged to penetrate through the back wall portion 12 in a thickness direction. A plurality of terminal accommodation chambers (not shown) capable of accommodating female terminal fittings are arranged in the terminal accommodating portion 17. A space between the large receptacle 13 and the terminal accommodating portion 17 serves as a space into which the small receptacle 31 is to be accommodated at the time of connection to the mating housing 30.

The large receptacle 13 includes a pair of supporting wall portions 14. The pair of supporting wall portions 14 are arranged parallel to each other and arranged along the pair of respective facing wall portions 32 in a state fit to the mating housing 30. Note that only one of the pair of supporting wall portions 14 is shown in FIGS. 1 to 6 due to space limitations. One supporting shaft 15 for rotatably supporting the lever 20 and one receiving groove 16 for receiving the pedestal portion 33 are arranged on each of the pair of supporting wall portions 14. The supporting shaft 15 is a substantially cylindrical shaft portion and projects outward from each supporting wall portion 14. The receiving groove 16 is a groove recessed toward the back wall portion 12 with respect to the opening edge 13E of the large receptacle 13. An opening edge of the receiving groove 16 is chamfered to serve as a guiding portion 16T for guiding the pedestal portion 33.

The lever 20 is made of synthetic resin and a substantially U-shaped member including a pair of cam plate portions 21 arranged parallel to each other across the housing 10 and a coupling portion 26 coupling this pair of cam plate portions 21. Note that only one of the pair of cam plate portions 21 is shown in FIGS. 1 to 6 due to space limitations.

Each of the pair of cam plate portions 21 is a plate-like part arranged to face the corresponding one of the two supporting wall portions 14. Each cam plate portion 21 includes a bearing hole portion 22 for receiving the supporting shaft 15 and a cam groove 23 for receiving the cam follower 34.

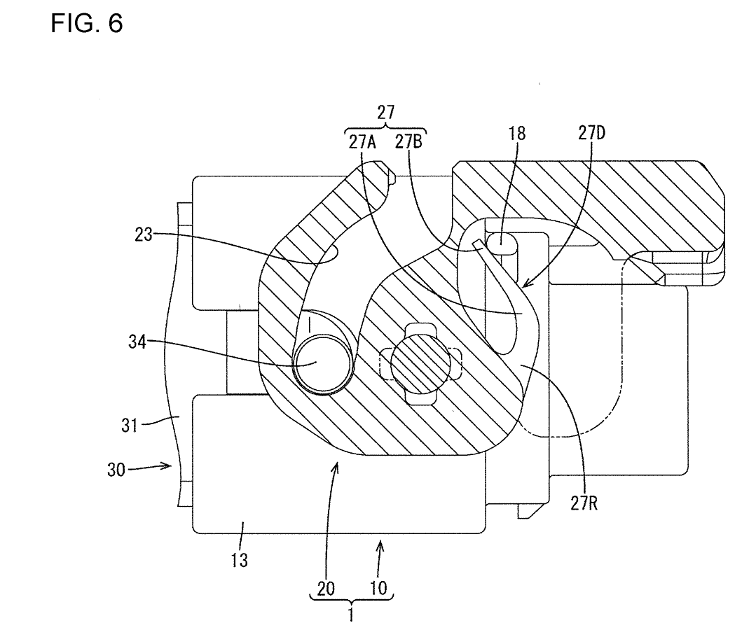

The bearing hole portion 22 is a circular hole portion recessed inwardly with respect to a surface of the cam plate portion 21 facing the supporting wall portion 14. The lever 20 is mounted to straddle the housing 10 by fitting the supporting shafts 15 into the respective bearing hole portions 22 and rotatably supported between an initial position (position shown in FIG. 1) and a proper connection position (position shown in FIG. 6).

Each cam plate portion 21 includes a first side Si (left side in FIG. 1) arranged in proximity to the opening edge 13E of the housing 10 when the lever 20 is arranged at the initial position and a second side 21S2 (right side in FIG. 1) located on a side opposite to the first side 21S1. The first side 21S1 is retracted from the opening edge 13E of the housing 10 (closer to the back wall portion 12) with the lever 20 arranged at the initial position.

The cam groove 23 is a groove recessed inwardly with respect to the surface of the cam plate portion 21 facing the supporting wall portion 14, includes an opening (entrance portion 23E) for allowing the entrance of the cam follower 34 and extends from this entrance portion 23E toward the second side 21S2. The cam groove 23 is substantially arcuate to gradually approach the bearing hole portion 22 as a center of rotation of the cam plate portion 21 from the entrance portion 23E toward a back side.

The coupling portion 26 is a part coupling the pair of cam plate portions 21 to each other. Each cam plate portion 21 includes a side (upper side in FIG. 1; third side 21S3) extending perpendicular to the first side 21S1 and the second side 21S2 and arranged on a side opposite to the cam groove 23 across the bearing hole portion 22, and both end parts of the coupling portion 26 are respectively connected to the third sides 21S3 of the respective cam plate portions 21. The coupling portion 26 includes a lock portion although not shown in detail. Further, the housing 10 includes a lock receiving portion 19 to be engaged with the lock portion when the lever 20 is rotated to the proper connection position.

The lever 20 includes push-back pieces 27 (corresponding to a push-back portion) which are connected to the cam plate portions 21 and function to detect whether or not the lever 20 has been rotated to the proper connection position. To arrange the push-back piece 27, the cam plate portion 21 includes a recess 24 recessed inwardly with respect to the surface of the cam plate portion 21 facing the supporting wall portion 14. The recess 24 is arranged on a side opposite to the cam groove 23 across the bearing hole portion 22. A peripheral wall 25 rising in a direction perpendicular to a plate surface of the cam plate portion 21 (direction perpendicular to the plane of FIG. 1) is arranged on a part proximate to the first side 21S1 (left part in FIG. 1) and a part proximate to the cam groove 23 and the bearing hole portion 22 (lower part in FIG. 1).

The push-back piece 27 is arranged in the recess 24 (i.e. on a side opposite to the cam groove 23 across the bearing hole portion 22) and includes a body portion 27A and a hook portion 27B. The body portion 27A is a bar-like part extending from the peripheral wall 25. The hook portion 27B is a bar-like part shorter than the body portion 27A, connected to an extending end of the body portion 27A and extending at an angle to the body portion 27A. The body portion 27A has a shape tapered toward the extending end from one end part (base portion 27R) connected to the peripheral wall 25. On the other hand, the hook portion 27B has the same thickness over the entire length from one end part connected to the body portion 27A to an extending end.

The base portion 27R of the push-back piece 27 and the bearing hole portion 22 are arranged side by side in a direction substantially parallel to the first side 21S1 (vertical direction of FIG. 1). The body portion 27A extends toward the first side 21S1 and is inclined outwardly (to approach the third side 21S3) toward the extending end. An angle a of a corner part C formed between a line connecting a center of the bearing hole portion 22 as the center of rotation of the cam plate portion 21 and the base portion 27R and the body portion 27A is larger than 90°. More specifically, the body portion 27A has two side edges 27C, 27D arranged along an extending direction thereof. When a part connected to the peripheral wall 25 of the recess 24 on the side edge 27C arranged closer to the bearing hole portion 22 out of the two side edges 27C, 27D is a base end 27S and a line connecting a center 22R of the bearing hole portion 22 and the base end 27S (shown by dashed-dotted line in FIG. 1) is a line L, the corner part C is a corner part formed by the line L and the side edge 27C.

Further, the hook portion 27B is inclined with respect to the body portion 27A to approach the second side 21S2 from a connected end to the body portion 27A toward a tip.

Further, push-back piece receiving portions 18 with which the push-back pieces 27 come into contact are arranged on the housing 10. The push-back piece receiving portion 18 is a part projecting outward from an outer surface of the housing 10 and arranged on a movement path of the push-back piece 27 when the lever 20 is rotated from the initial position to the proper connection position.

[Connection of Housing 10 to Mating Housing 30]

Next, an operation of connecting the housing 10 to the mating housing 30 by rotating the lever 20 from the initial position to the proper connection position is described.

When the lever 20 is arranged at the initial position, the entrance portions 23E of the cam grooves 23 are arranged inside the receiving grooves 16 and open toward the mating housing 30, whereby the cam grooves 23 are set in a state to allow the entrance of the cam followers 34 thereinto.

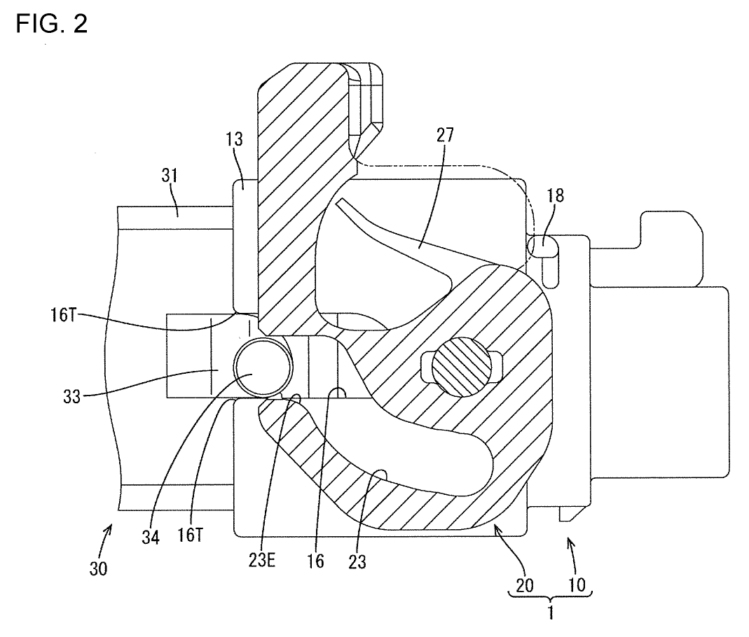

From this state, the small receptacle 31 of the mating housing 30 is fit into the large receptacle 13 of the lever-type connector 1. At this time, as shown in FIG. 2, the pedestal portions 33 are inserted into the receiving grooves 16 while being guided by the guiding portions 16T. In this way, the housing 10 and the mating housing 30 are positioned. When the mating housing 30 is shallowly fit into the housing 10, the cam followers 34 enter the entrances 23E of the cam grooves.

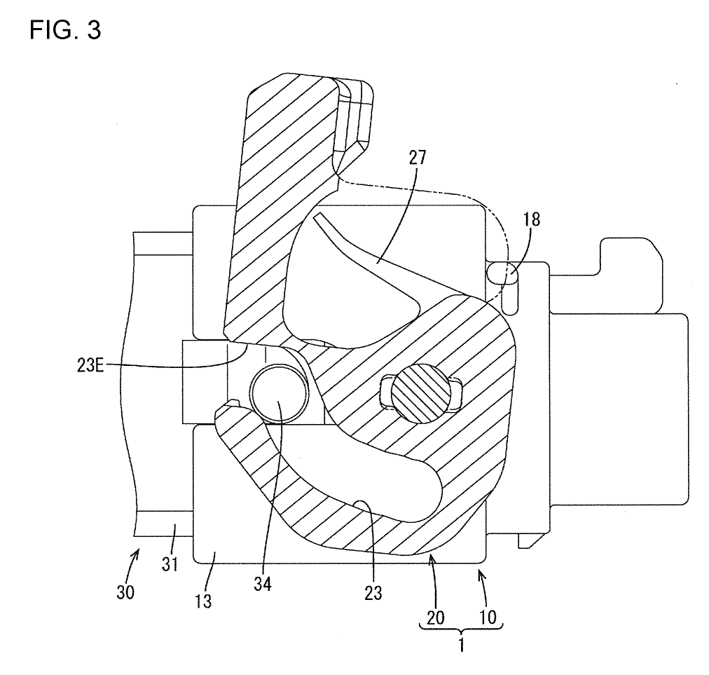

As the lever 20 is rotated from the initial position to the proper connection position from this state, the cam followers 34 move from the entrance portions 23 toward back ends along the peripheral edges of the cam grooves 23 as shown in FIG. 3, whereby the mating housing 30 is relatively pulled into the housing 10 and connection proceeds.

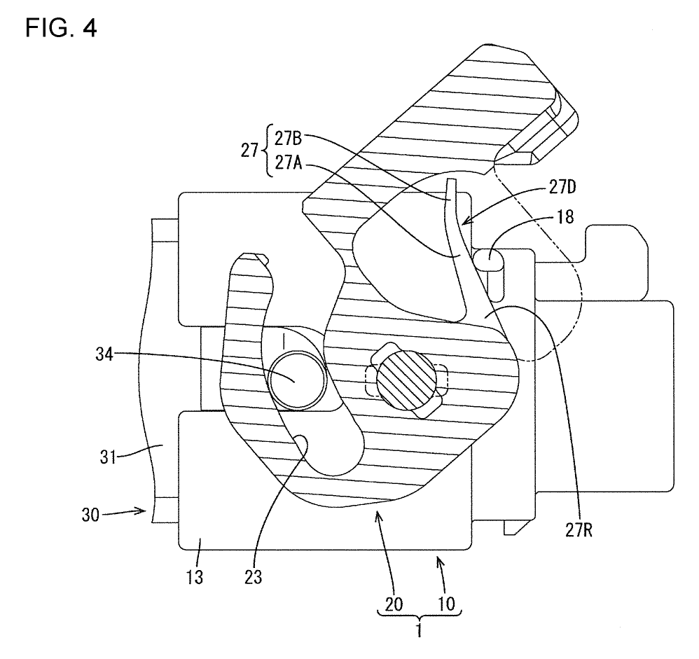

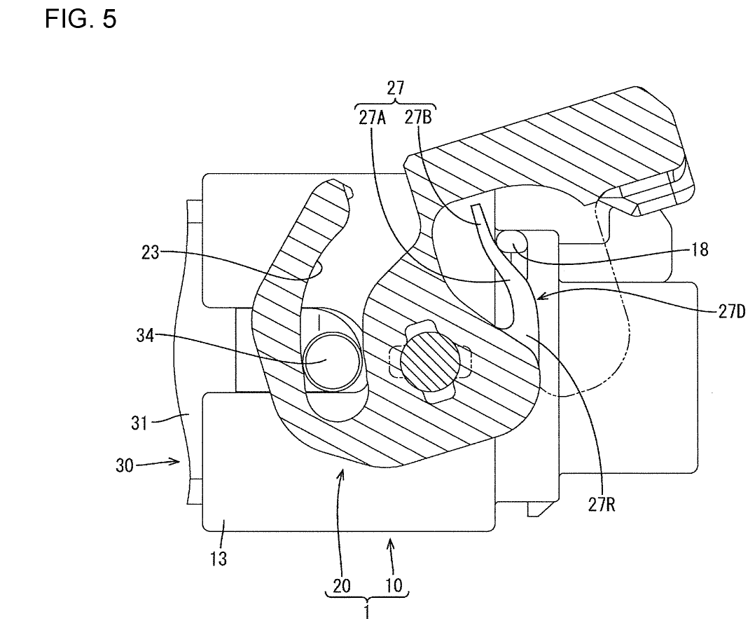

When the lever 20 is rotated to the vicinity of the proper connection position, the side edges 27D of the push-back pieces 27 come into contact with the push-back piece receiving portions 18 as shown in FIG. 4. At this time, the push-back piece receiving portion 18 is in contact with the body portion 27A at a position close to the base portion 27R. When the lever 20 is further rotated toward the proper connection position, the push-back pieces 27 are resiliently deformed while being held in contact with the push-back piece receiving portions 18 as shown in FIG. 5. At this time, the push-back piece receiving portion 18 moves in a direction toward the hook portion 27B while sliding in contact with the side edge 27D.

When the lever 20 reaches the proper connection position, the housing 10 and the mating housing 30 reach a properly connected state as shown in FIG. 6. In the properly connected state, the lever 20 is biased toward the initial position by resilient restoring forces of the push-back pieces 27, but the rotation of the lever 20 to the initial position is restricted by the engagement of the lock portion and the lock receiving portion 19. At this time, the push-back piece receiving portion 18 is caught by the hook portion 27B, a bent part between the body portion 27A and the hook portion 27B is stretched and the push-back piece 27 extends substantially straight over the entire length from the base portion 27R to the extending end of the hook portion 27B.

Here, if the housing 10 and the mating housing 30 are incompletely connected (state shown in FIG. 5) such as due to the end of the rotational operation of the lever 20 immediately before the lever 20 reaches the proper connection position, the lever 20 is pushed back toward the initial position by the resilient restoring forces of the push-back pieces 27. In this way, it is detected that the lever 20 has not reached the proper connection position. In other words, the incompletely connected state of the housing 10 and the mating housing 30 can be detected.

[Functions and Effects]

As described above, for the purpose of miniaturizing the lever-type connector 1, the cam plate portions 21 are retracted from the opening edge 13E of the housing 10 at the initial position. In other words, a distance between the first and second sides 21S1, 21S2 of the cam plate portion 21 becomes shorter than before and the cam plate portion 21 is miniaturized in the direction perpendicular to the first and second sides 21S1, 21S2. Thus, incomplete connection detection capability may be reduced due to the push-back piece 27 made shorter by as much as the cam plate portion 21 is miniaturized and the weakening of the resilient restoring force.

Accordingly, in this embodiment, the angle a of the corner part C formed by the line connecting the center of the bearing hole portion 22 and the base portion 27R of the push-back piece 27 and the push-back piece 27 is made larger than 90°. By setting such a large angle a of the corner part C, the push-back piece 27 can be arranged with a large inclination with respect to a direction in which the cam plate portion 21 is miniaturized, i.e. arranged in a direction in which a larger space is present, and sufficient length and deflection margin of the push-back piece 27 can be ensured. In this way, it is possible to avoid a reduction of the incomplete connection detection capability while realizing the miniaturization of the lever-type connector 1.

Further, when the lever 20 is at the proper connection position, the push-back pieces 27 are kept resiliently deformed by the push-back piece receiving portions 18. Thus, if a long period of time elapses with this state kept, the push-back pieces 27 are plastically deformed to reduce the resilient restoring forces, whereby the incomplete connection detection capability may be reduced. Accordingly, in this embodiment, the body portions 27A of the push-back pieces 27 are tapered. According to this configuration, deformation in a peripheral area of the base portion 27R susceptible to plastic deformation can be relatively reduced and a reduction of the incomplete connection detection capability by the plastic deformation of the push-back piece 27 can be avoided by making the bending of a part of the body portion 27A near the extending end larger.

On the other hand, the hook portion 27B has the same thickness over the entire length thereof. According to this configuration, it is possible to avoid that tip parts of the push-back pieces 27, i.e. parts to be caught by the push-back piece receiving portions 18 when the lever 20 is at the proper connection position are excessively bent and suppress that the push-back pieces 27 are disengaged from the push-back piece receiving portions 18.

### Other Embodiments

The technique disclosed by this specification is not limited to the above described and illustrated embodiment. For example, the following various modes are also included.

(1) Although the lever 20 is a member including the pair of cam plate portions 21 and the coupling portion 26 coupling this pair of cam plate portions 21 in the above embodiment, a lever may be a member with only one cam plate portion.

(2) Although the lever-type connector 1 is a female connector including the female terminal fittings in the above embodiment, a lever-type connector may be a male connector including male terminal fittings and a mating housing may include female terminal fittings.

### LIST OF REFERENCE SIGNS

1 . . . lever-type connector
10 . . . connector housing
18 . . . push-back piece receiving portion
20 . . . lever
21 . . . cam plate portion
23 . . . cam groove
27 . . . push-back piece (push-back portion)
27A . . . body portion
27B . . . hook portion
27R . . . base portion (one end part)
30 . . . mating housing
34 . . . cam follower
C . . . corner part

1. A lever-type connector to be connected to a mating housing including a cam follower, comprising:
a connector housing; and
a lever including a cam plate having a cam groove for receiving the cam follower and configured to pull the mating housing toward the connector housing by a cam action of the cam groove and the cam follower as the lever is rotated from an initial position for allowing the entrance of the cam follower into the cam groove to a proper connection position;
wherein:
the lever includes a push-back portion extending from the cam plate and retracted from an end edge of the connector housing facing the mating housing;
the connector housing includes a push-back piece receiving portion configured to bias the lever from the proper connection position toward the initial position by contacting the push-back portion when the lever is at the proper connection position; and
an angle of a corner part formed by a line connecting a center of rotation of the lever and one end part of the push-back portion connected to the cam plate and the push-back portion is larger than 90°.

2. The lever-type connector of claim 1, wherein the push-back portion includes a body portion connected to the cam plate and a hook connected to an extending end of the body and extending at an angle to the body, and the body is tapered from a base end toward the extending end.

3. The lever-type connector of claim 2, wherein the hook has a uniform thickness over the entire length.
